(19) United States
(12) Patent Application Publication
(10) Pub. No.: US 2011/0108431 A1
(43) Pub. Date: May 12, 2011

(54) Galvanization system and method of galvanizing treatment using thereof

(75) Inventors: Kazuyuki Shinozaki, Chigasaki-shi (JP); Yusaku Tazono, Chigasaki-shi (JP); Katsuhiro Koike, Chigasaki-shi (JP)

(73) Assignees: Nihon Hyomen Kagaku Kabushiki Kaisha, Tokyo (JP); Kidaseiko Kabushiki Kaisha, Osaka (JP)

(21) Appl. No.: 12/653,427

(22) Filed: Dec. 14, 2009

Related U.S. Application Data
(63) Continuation-in-part of application No. 12/590,684, filed on Nov. 12, 2009.

(51) Int. Cl. C25D 3/22; C25B 9/06; C11D 3/37

(52) U.S. Cl. 205/309; 204/242; 510/109

(57) ABSTRACT

A galvanization system comprising an alkaline galvanization bath, a positive electrode, and a negative electrode is provided. The alkaline galvanization bath comprises galvanizing solution including about 7 to about 60 g/l of Zn, about 70 to about 200 g/l of alkali hydroxide and about 0.01 to about 5 g/l of additives. The positive electrode is insoluble in the galvanizing solution, having an opposed surface to an object which is supposed to be set in the alkaline galvanization bath and galvanized. The opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm. The galvanization system can produce a galvanization membrane of excellent appearance.

### FIELD OF THE INVENTION

The present invention relates to a galvanization system and method of galvanizing treatment using thereof.

### BACKGROUND OF THE INVENTION

Auto manufacturers and the like recently request high corrosion resistance (for example, white rust is not found for 72 hours in a salt spray test) in a coating. In all sorts of coating, a galvanization is practically the only coating that has an effect of sacrificial corrosion prevention. Further, the galvanization can be carried at lower cost than that of other coatings. Accordingly, it is used the most. The galvanization is classified into two types, one is a galvanization using galvanizing solution (pH: about 4 to about 6) which is generally called acidic bath and the other is a galvanization using alkaline bath (pH: over 14). Further, the alkaline bath is classified into a cyanide bath which includes cyanogens and a zincate bath which does not include cyanogens. The acidic bath has features such as giving beautiful lustrous appearance. The cyanide bath has features such as giving membrane of good workability. However, tightening of regulations of industrial wastewater and the like has been promoted in accordance with a heightening of consciousness to environment of recent years, and there has been a movement to review the galvanizing solution. In particular, it is no wonder that the cyanide bath has hazardous nature because it includes deadly poison of cyanogens. The acidic bath has problems about, for example, removal performance of heavy metal, high COD and high BOD caused by a brightening agent, because it includes ammonia in the galvanizing solution. On the other hand, the zincate bath gains an edge on these bath in the environmental terms of an easiness of wasterwater treatment and the like because it does not include cyanogens and ammonia. Further, the zincate bath has an advantage of having higher corrosion resistance than that of other baths on requests of progress of the corrosion resistance in recent years.

### SUMMARY OF THE INVENTION

However, the zincate bath has a disadvantage that appearance of membrane produced by the bath tends to be inhomogeneous specifically by heating after coating treatment.

An object of the present application is to provide a galvanization system that can produce a galvanization membrane of excellent appearance by improving disadvantages of a zincate bath that does not include toxic materials such as cyanogens and can reduce the strain on environment with satisfying requests for high corrosion resistance from auto manufacturers and so on. Another object of the present invention is to provide a method of galvanizing treatment using the galvanization system.

The inventors have extensively investigated to overcome the above problems and have drawn attention not only to compositions of galvanizing solution and additives that have been taken into consideration but to function of positive electrode of counter electrode. In general, the galvanization is carried in the negative electrode and the positive electrode is thought to be a supply port of electricity to the solution or a supply source of electrocrystallization metal to the galvanizing solution. Accordingly, even if zinc plate is used for the positive electrode in the galvanization and copper plate is used for the positive electrode in a copper plating, the zinc plate and copper plate are not used in a nickel plating. As mentioned above, the function of the positive electrode is simply grasped, therefore the positive electrode has hardly been paid attention to on a solution of the problem. The inventors also investigated with paying little attention to the positive electrode at the beginning. However, at one point, they found that, even if same additives are used, appearances of membrane produced by using different compositions of the positive electrode are different from each other, then they found a clue to solve the problem as a result of further keen examination.

In one aspect, the present invention completed as the basis of the above knowledge is:

a galvanization system comprising:

an alkaline galvanization bath comprising galvanizing solution including about 7 to about 60 g/l of Zn, about 70 to about 200 g/l of alkali hydroxide and about 0.01 to about 5 g/l of additives;

a positive electrode which is insoluble in the galvanizing solution, having an opposed surface to an object which is supposed to be set in the alkaline galvanization bath and galvanized; and

a negative electrode,

wherein the opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm.

In one embodiment, the present invention is:

the galvanization system further comprising a washing bath that the object is supposed to be set in before the coating treatment, including about 5 to about 100 g/l of alkali hydroxide and at least one selected from the group consisting of (a) about 1 to about 100 g/l of a surface acting agent, (b) organic acid or salt thereof, (c) phosphorus oxygen acid and (d) an aliphatic amine compound.

In preferred embodiment, the present invention is:

the galvanization system further comprising an acid bath that the object is supposed to be set in after the washing treatment in the washing bath and before the coating treatment, or set in during multiple times of the washing treatment and before the coating treatment.

In another preferred embodiment, the present invention is:

the galvanization system further comprising an acid bath that the object is supposed to be set in after the coating treatment.

In another preferred embodiment, the present invention is:

the galvanization system according to claim 1, further comprising an aftertreatment bath that the object is supposed to be set in after the coating treatment and treated, wherein the aftertreatment bath includes acid aqueous solution including at least one selected from the group consisting of Cr, Co, Zn, Ni and Ag, and at least one selected from the group consisting of chlorine ion, sulfate ion and nitrate ion.

In another preferred embodiment, the present invention is:

the galvanization system wherein the acid aqueous solution further comprises at least one selected from the group consisting of silica, organic acid, phosphorus oxygen acid and fluorine compound.

In another preferred embodiment, the present invention is:

the galvanization system further comprising an alkaline treatment part that treats the object with alkaline aqueous solution including at least one selected from the group consisting of Si, acrylate resin, wax and silica resin after the aftertreatment.

In another preferred embodiment, the present invention is:

the galvanization system wherein the opposed surface of the positive electrode is formed in a rectangular pattern having a side over 3 mm and equal to or less than 25 mm, which connects arbitrary two apexes of the pattern, in a polygonal pattern having a vertical line over 3 mm and equal to or less than 25 mm, drawn between an arbitrary apex and an arbitrary side of the pattern, or in a circular pattern having a diameter over 3 mm and equal to or less than 25 mm.

In another preferred embodiment, the present invention is:

the galvanization system wherein the positive electrode is made of Fe, carbon, Ni, Co, stainless steel, Ti or alloyed metal including at least one selected from the group consisting thereof.

In another preferred embodiment, the present invention is:

the galvanization system wherein the plural positive electrodes are set in parallel.

In another preferred embodiment, the present invention is:

the galvanization system wherein the additives comprises:

a polymer having a structure of the formula (I); and

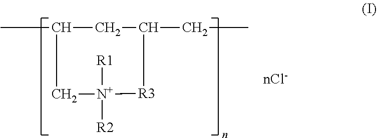

(In the formula (I), R1 and R2 indicate H, CH₃, C₂H₅, C₃H₇ or C₄H₉, R3 indicates CH₂, C₂H₄ or C₃H₆, n indicates an integral number equal to or more than 1.)
a polymer having a structure of the formula (II);

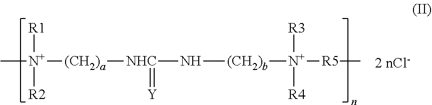

(In the formula (II), R1, R2, R3 and R4 indicate H, CH₃, C₂H₅, C₃H₇ or C₄H₉—CH₂—CH(OH)—CH₂CH₂(OCCH₂CH₂)XOH (X=0 to 6), R5 indicates —CH₂—CH₂—O—CH₂—CH₂—, —(CH₂—CH₂—O)₂—CH₂—CH₂— or —CH₂—CH(OH)—CH₂—O—CH₂—CH(OH)—CH₂—, a and b indicate 2 to 4, n indicates an integral number equal to or more than 1, Y indicates S or O.)

and further comprises at least one selected from the group consisting of:

a reaction product of aliphatic amine and epihalohydrin;

a reaction product of (a) urea or thiourea, (b) dialkylaminoethylamine and/or dialkylaminopropylamine and (c) dichloroalkylether; and

polyethyleneimine compound.

In another preferred embodiment, the present invention is:

the galvanization system wherein the additives comprises at least one selected from the group consisting of:

aromatic aldehyde and derivatives thereof;

benzylpyridiniumcarboxylate; surface acting agent;

(a) nicotine acid and (b) halogenated hydrocarbon; and

a reaction product of alkylene oxide, halogen ether and epihalohydrin.

In another aspect, the present invention is:

a method for galvanizing a surface of an object, using a galvanization system comprising:

an alkaline galvanization bath comprising galvanizing solution including about 7 to about 60 g/l of Zn, about 70 to about 200 g/l of alkali hydroxide and about 0.01 to about 5 g/l of additives;

a positive electrode which is insoluble in the galvanizing solution, having an opposed surface to an object which is supposed to be set in the alkaline galvanization bath and galvanized; and a negative electrode,

wherein the opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm.

In one embodiment, the present invention is:

the method wherein an average current density of the negative electrode is about 0.4 to about 50 A/dm².

In preferred embodiment, the present invention is:

the method according to claim 12, wherein an average current density of the opposed surface of the positive electrode is about 0.5 to about 100 A/dm².

In another embodiment, the present invention is:

the method wherein an average galvanizing rate is equal to or more than about 0.1 μm/min in a barrel galvanizing and equal to or more than about 0.3 μm/min in a rack galvanizing.

In another aspect, the present invention is:

additives for the galvanization system comprising:

a polymer having a structure of the formula (I); and

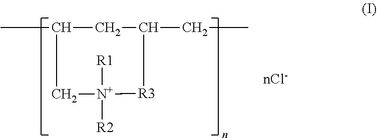

(In the formula (I), R1 and R2 indicate H, CH₃, C₂H₅, C₃H₇ or C₄H₉, R3 indicates CH₂, C₂H₄ or C₃H₆, n indicates an integral number equal to or more than 1.)
a polymer having a structure of the formula (II);

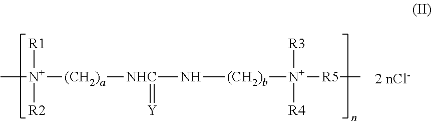

(In the formula (II), R1, R2, R3 and R4 indicate H, CH₃, C₂H₅, C₃H₇ or C₄H₉—CH₂—CH(OH)—CH₂CH₂(OCCH₂CH₂)XOH (X=0 to 6), R5 indicates —CH₂—CH₂—O—CH₂—CH₂—, —(CH₂—CH₂—O)₂—CH₂—CH₂— or —CH₂—CH(OH)—CH₂—O—CH₂—CH(OH)—CH₂—, a and b indicate 2 to 4, n indicates an integral number equal to or more than 1, Y indicates S or O.)

and further comprises at least one selected from the group consisting of:

a reaction product of aliphatic amine and epihalohydrin;

a reaction product of (a) urea or thiourea, (b) dialkylaminoethylamine and/or dialkylaminopropylamine and (c) dichloroalkylether; and

polyethyleneimine compound.

In another aspect, the present invention is:

a washing agent for the washing bath of the galvanization system comprising at least one selected from the group consisting of anionic system surface acting agent, nonionic system surface acting agent, organic carboxylic acid or salt thereof, EDTA salt, NTA salt, phosphoric acid, pyrophoric acid, phosphorous acid, hypophosphorous acid or salt thereof, aliphatic amine of carbon number equal to or less than 12 or reaction product of the aliphatic amine and epihalohydrin.

In another aspect, the present invention is:

an aftertreatment acid aqueous solution for the aftertreatment bath of the galvanization system comprising at least one selected from the group consisting of Cr, Co, Zn, Ni and Ag, and at least one selected from the group consisting of chlorine ion, sulfate ion and nitrate ion, and optionally at least one selected from the group consisting of silica, organic acid, phosphorus oxygen acid and fluorine compound.

In another aspect, the present invention is:

an aftertreatment alkaline aqueous solution for the alkaline treatment part of the galvanization system comprising at least one selected from the group consisting of silica, acrylate resin, wax and silica resin.

The present invention can provide a galvanization system and method of galvanizing treatment using thereof that can produce a galvanization membrane of excellent appearance.

### DESCRIPTION OF THE DRAWINGS

FIG. 1 is a perspective view of the positive electrode of the galvanization system.

FIG. 2 is a side view of the positive electrode opposed to the barrel in the galvanization system.

### DESCRIPTION OF THE PREFERRED EMBODIMENT

### Galvanization System

In the preferred embodiment, the galvanization system of the present invention comprises:

an alkaline galvanization bath comprising galvanizing solution including about 7 to about 60 g/l of Zn, about 70 to about 200 g/l of alkali hydroxide and about 0.01 to about 5 g/l of additives;

a positive electrode which is insoluble in the galvanizing solution, having an opposed surface to an object which is supposed to be set in the alkaline galvanization bath and galvanized; and

a negative electrode.

The positive electrode has at least one opposed surface to the object. The positive electrode is formed in, for example, a shape of a rectangular parallelepiped. The opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm. Preferably, the opposed surface of the positive electrode is formed in a rectangular pattern having a side over 3 mm and equal to or less than 25 mm, which connects arbitrary two apexes of the pattern, in a polygonal pattern having a vertical line over 3 mm and equal to or less than 25 mm, drawn between an arbitrary apex and an arbitrary side of the pattern, or in a circular pattern having a diameter over 3 mm and equal to or less than 25 mm. If the positive electrode is formed in a spherical pattern, its projection image has circular form.

In this case, the above specification is applied with respect to its diameter. The positive electrode is made of, for example, Fe, carbon, Ni, Co, stainless steel, Ti or alloyed metal including at least one selected from the group consisting thereof.

The plural positive electrodes may be set in parallel to the object. Thus, a galvanization membrane of excellent appearance can be efficiently produced by the setting of the plural positive electrodes in parallel to the object because electrical current flows more uniformly. The plural positive electrodes are preferably set at intervals of 3 to 100 mm, more preferably 10 to 50 mm. If the intervals is less than 3 mm, optimum current density of the positive electrodes cannot be obtained because a lot of the positive electrodes is needed and then the current density of the positive electrodes become too low. If the intervals is over 100 mm, uniformity of the electrical current deteriorates.

The above opposed surface of the positive electrode indicates a surface opposing to the object and crosses nearly perpendicular to a direction from the positive electrode to the object.

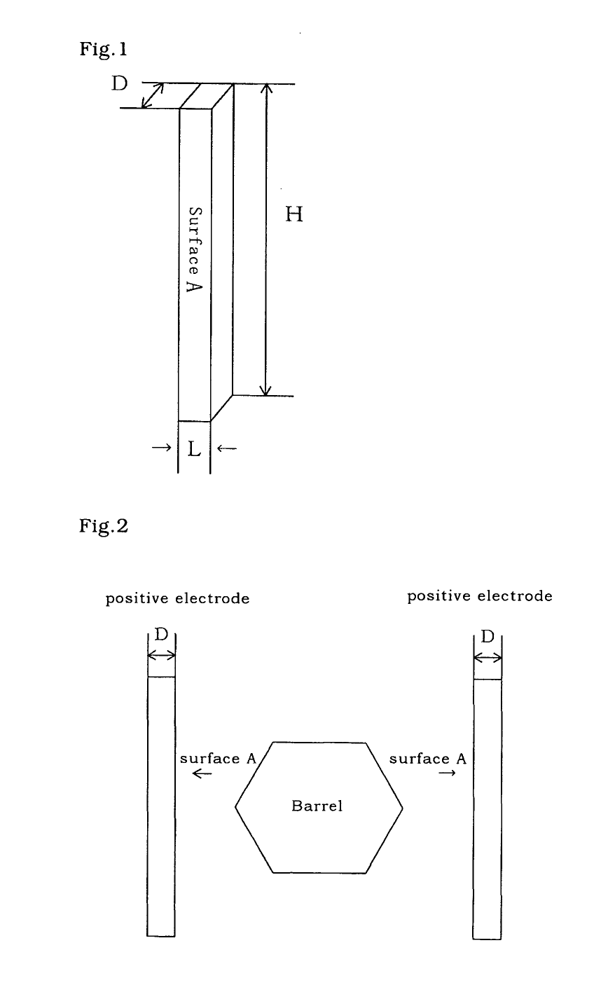

As a specific example of the positive electrode, FIG. 1 indicates a perspective view of the positive electrode of the galvanization system and FIG. 2 indicates a side view of the positive electrode opposed to the barrel in the galvanization system. In FIGS. 1 and 2, “Surface A” indicates the opposed surface to the object, “L” indicates a width of “Surface A”, “H” indicates a height of “Surface A” and “D” indicates a depth of the positive electrode. “L” is equal to or less than 30 mm in FIGS. 1 and 2. Though such positive electrodes formed in a shape of a rectangular parallelepiped are set in a longitudinal direction in FIGS. 1 and 2, that is not limited to such a configuration. That is, the positive electrodes may be set, for example, in a transverse direction. In addition, though the positive electrodes are set separately in FIG. 2, they may be configured to connect with each other by passing under the object. In the case of setting in a longitudinal direction as described in FIG. 1, “H” is mostly determined by a size of a galvanizing bath. For example, in the case of a rack galvanizing, a length of “H” is preferably equal to or somewhat less than that of the rack. “D” is generally 10 to 150 mm and practically 20 to 70 mm. If “D” is less than 10 mm, “L” is equal to or less than 30 mm and it is anticipated that a problem of strength poverty may occur. Accordingly, it is anticipated that the positive electrode may transform because of a circulation of the galvanizing solution and the like, and as a result, an unfavorable problem of a contact (such as a short circuit) of the positive electrode and the negative electrode (a barrel in the case of a rotation plating) may occur. In addition, if “D” is long, a volume of little relevance to galvanizing will increase and a bath of an excessive size will be needed. As a result, there will be a lot of disadvantages such as increases of cost of equipments and installation space.

Examples of the alkali hydroxide in the alkaline galvanization bath may include lithium hydroxide, sodium hydroxide, potassium hydroxide and the like.

The additives in the alkaline galvanization bath may comprise:

a polymer having a structure of the formula (I); and

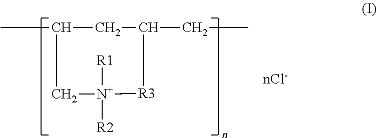

(In the formula (I), R1 and R2 indicate H, CH₃, C₂H₅, C₃H₇ or C₄H₉, R3 indicates CH₂, C₂H₄ or C₃H₆, n indicates an integral number equal to or more than 1.) a polymer having a structure of the formula (II);

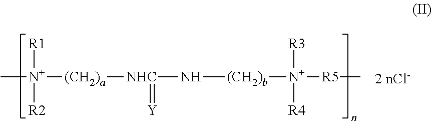

(In the formula (II), R1, R2, R3 and R4 indicate H, CH₃, C₂H₅, C₃H₇ or C₄H₉—CH₂—CH(OH)—CH₂CH₂(OCCH₂CH₂)XOH (X=0 to 6), R5 indicates —CH₂—CH₂—O—CH₂—CH₂—, —(CH₂—CH₂—O)₂—CH₂—CH₂— or —CH₂—CH(OH)—CH₂—O—CH₂—CH(OH)—CH₂—, a and b indicate 2 to 4, n indicates an integral number equal to or more than 1, Y indicates S or O.)

and further comprises at least one selected from the group consisting of:

a reaction product of aliphatic amine and epihalohydrin;

a reaction product of (a) urea or thiourea, (b) dialkylaminoethylamine and/or dialkylaminopropylamine and (c) dichloroalkylether; and

polyethyleneimine compound.

In another example, the additives in the alkaline galvanization bath may comprise:

at least one selected from the group consisting of:

aromatic aldehyde and derivatives thereof;

benzylpyridiniumcarboxylate;

surface acting agent;

(a) nicotine acid and (b) halogenated hydrocarbon; and

a reaction product of alkylene oxide, halogen ether and epihalohydrin.

Examples of the aliphatic amine may include at least one selected from the group consisting of triethanolamine, ethylenediamine, pentaethylenehexamine, diaminopropane, diethylenetriamine, ethylaminoethanol, aminopropylethylenediamine, bisaminopropylpiperazine, triethylenetetramine, hexamethylenetetramine, isopropanolamine, aminoalcohol, imidazole, picoline, piperazine, methylpiperazine, morpholine, hydroxyethylaminopropylamine, tetramethylpropylenediamine, dimethylaminopropylamine, dimethylaminoethylamine, diethylaminoethylamine, dipropylaminoethylamine, dibuthylaminoethylamine, diethylaminopropylamine, dipropylaminopropylamine and dibuthylaminopropylamine.

The dichloroalkylether may be dichloroalkylether of carbon number 1 to 5, preferably equal to or less than 4, and examples of the dichloroalkylether may include dichloroethylether, dichlorobuthylether and dichloropropylether.

Examples of the surface acting agent may include common various surface acting agents, aromatic aldehyde such as anisaldehyde, vanillin, heliotropin, veratraldehyde, benzaldehyde and hydroxybenzaldehyde as aldehyde, or methyl substitution product thereof, and formalin.

The galvanization system may comprise a washing bath that the object is supposed to be set in before the coating treatment, including about 5 to about 100 g/l of alkali hydroxide and at least one selected from the group consisting of (a) about 1 to about 100 g/l of a surface acting agent, (b) organic acid or salt thereof, (c) phosphorus oxygen acid and (d) an aliphatic amine compound.

Examples of the phosphorus oxygen acid may include orthophosphoric acid, condensed phosphoric acid, hypophosphorous acid, phosphorous acid and salt thereof, and its concentration in the solution is about 0.5 to about 80 g/l, preferably about 1 to about 60 g/l. In addition, it is necessary for molar ratio of phosphorus and trivalent chrome (P/Cr) to be about 0.3 to about 25, preferably about 1 to about 10. If the P/Cr is less than that, it is difficult to produce a galvanization membrane of excellent appearance and required functions may not be provided. If the P/Cr is more than that, demerits of functional decline and increasing of cost may occur because of an excess inclusion.

The galvanization system may comprise an acid bath that the object is supposed to be set in after the coating treatment and neutralized.

The galvanization system may further comprise an aftertreatment bath that the object is supposed to be set in after the coating treatment and treated, wherein the aftertreatment bath includes acid aqueous solution including at least one selected from the group consisting of Cr, Co, Zn, Ni and Ag, and at least one selected from the group consisting of chlorine ion, sulfate ion and nitrate ion.

The acid aqueous solution further may comprise at least one selected from the group consisting of silica, organic acid, phosphorus oxygen acid and fluorine compound.

The fluorine compound specifically has advantageous effects on an improvement of excellent appearance of a galvanization membrane. However, an excess inclusion of the compound causes a degradation of a corrosion resistance. Accordingly, it is preferable that a concentration of the fluorine compound is comparatively small, that is, about 0.1 to 5 g/l, and it is more preferable that the concentration is about 0.2 to about 3 g/l.

The galvanization system may further comprise an alkaline treatment part that treats the object with alkaline aqueous solution including at least one selected from the group consisting of silica, acrylate resin, wax and silica resin after the aftertreatment. By using the alkaline treatment part, a friction coefficient can be controlled and a corrosion resistance can be further improved. The alkaline treatment part may be an alkaline bath including alkaline aqueous solution or an alkaline aqueous solution injecting nozzle that injects alkaline aqueous solution to a surface of the object.

### Galvanizing Method Using the Galvanization System

In the preferred embodiment, the galvanizing method of the present invention uses the above galvanization system.

At first, it is preferable that the object is washed before galvanizing. It is preferable that the washing is conducted by setting the object in alkaline or acid aqueous solution, or by setting the object in alkaline or acid aqueous solution and then applying electrolysis to the object. The alkaline is given by various alkali hydroxides and the acid is given by hydrochloric acid, sulfuric acid and the like. In particular, the washing is conducted by setting the object in a washing bath including about 5 to about 100 g/l of alkali hydroxide and at least one selected from the group consisting of (a) about 1 to about 100 g/l of a surface acting agent, (b) organic acid or salt thereof, (c) phosphorus oxygen acid and (d) an aliphatic amine compound. In more particular, the above washing agent preferably includes at least one selected from the group consisting of anionic system surface acting agent, nonionic system surface acting agent, organic carboxylic acid or salt thereof, EDTA salt, NTA salt, phosphoric acid, pyrophoric acid, phosphorous acid, hypophosphorous acid or salt thereof, aliphatic amine of carbon number equal to or less than 12 or reaction product of the aliphatic amine and epihalohydrin.

Examples of the surface acting agent may include commercially available various surface acting agents, in particular, linear alkylbenzenesulfonate, α-olefinsulfonate and polyoxyethylenealkylethersulfate. Examples of counter ions of salt thereof may include alkali metal such as Na and K, alkali earth metal such as Mg, alkanolamine such as monoethanolamine, diethanolamine and triethanolamine. Examples of the more concrete commercially available linear alkylbenzenesulfonate may include “LIPON LS-250” (produced by Lion) and “TAYCAPOWER LN2065” (produced by Tayca). Examples of the more concrete α-olefinsulfonate may include “LIPOLAN PB-800” (produced by Lion). Examples of the more concrete polyoxyethylenealkylethersulfate may include “TAYCAPOLE NE1270” and “TAYCAPOLE NE1230” (produced by Tayca). In addition, polyoxyalkylenealkylether, alkylpolyglycerylester, alkylpolyglycerylether, methoxypolyoxyalkylenealkanoate, aliphatic acid diethanolamide, aliphatic acid monoethanolamide, alkylpolyglycoside and the like may be exemplified. Examples of the more concrete commercially available polyoxyalkylenealkylether may include “LEOCALL SC-90”, “LEOX CC-90”, “LEOCALL SC-120” and “LEOCALL TD-150” (produced by Lion), “EMALEX 705”, “EMALEX 715” and “EMALEX 720” (produced by Nihon Emulsion), and “NAROACTY 50”, “NAROACTY 100” and “NAROACTY 160” (produced by Sanyo Chemical Industries).

Examples of the organic acid or salt thereof may include at least one selected from the group consisting of monocarboxylic acid such as formic acid, acetic acid and propionic acid, dicarboxylic acid such as oxalic acid, malonic acid, succinic acid and adipic acid, tricarboxylic acid such as tricarbamic acid, hydroxycarboxylic acid such as glycolic acid, lactic acid, malic acid, tartaric acid and citric acid, aminocarboxylic acid such as glycine and alanine, and salt thereof. The organic acid is preferably dicarboxylic acid or tricarboxylic acid.

Examples of the aliphatic amine may include the above mentioned types of amine.

The above washing treatment is conducted at about 5 to about 80° C., preferably about 20 to about 70° C., for about 1 to about 30 minutes, preferably about 3 to about 20 minutes. In the case of electrolysis, the object is conducted the electrolytic treatment at about 5 to about 80° C., preferably about 20 to about 70° C., for about 1 to 30 minutes, preferably about 3 to about 20 minutes with positive current, negative current or alternateness thereof.

An after-mentioned may be conducted after the alkaline washing and the acid treatment by the acid bath. Further, the alkaline washing may be conducted again after the acid treatment and before the coating treatment.

The object is set in the alkaline galvanization bath. One surface (opposed surface) of the positive electrode opposes nearly perpendicular to the object. Electric current is passed through between the negative electrode and the positive electrode of the alkaline galvanization bath by supplying with voltage. The average current density of the negative electrode is controlled to about 0.4 to about 50 A/dm² (about 0.4 to about 7 A/dm², more preferably 0.5 to about 5 A/dm² in a barrel galvanizing, about 3 to about 50 A/dm², more preferably about 4 to about 30 A/dm² in a rack galvanizing). The average current density of the opposed surface of the positive electrode is controlled to about 0.5 to about 100 A/dm², preferably about 1 to about 80 A/dm², more preferably about 6 to about 40 A/dm², more preferably about 9 to about 30 A/dm². In the case that the coating treatment is the barrel galvanizing, the average galvanizing rate is controlled to equal to or more than about 0.1 μm/min, more preferably equal to or more than about 0.15 μm/min. In the case that the coating treatment is the rack galvanizing, the average galvanizing rate is controlled to equal to or more than about 0.3 μm/min, more preferably equal to or more than about 1 μm/min.

The temperature of the galvanizing solution is about 15 to about 65° C., more preferably about 20 to 55° C.

Conventional galvanization systems have a case containing rectangular or circular plates, or balls that are made of various types of metal as positive electrodes. If a plate of width:100 mm-length:200 mm-thickness:40 mm is used, its surface of width:100 mm-length:200 mm is opposed to the object. A size of the case is determined according to plates or balls contained in the case. Examples of the metal plates include, for example, plates of width:100 to 200 mm-length:200 to 1000 mm-thickness:40 to 50 mm. There are plates that have lager size of the above width and length because they are determined according to a size of a bath. The diameters of the circular plate and ball are 50 to 80 mm.

On the other hand, the galvanization system in the embodiment of the present invention, as mentioned above, does not require plating metal supply sources of positive electrode plates, the system has an insoluble positive electrode and a separate bath and an opposed surface to the object in each insoluble positive electrode has one side or a diameter equal to or less than 30 mm. Thus, by making one side or a diameter of the opposed surface to the object in the positive electrode equal to or less than 30 mm, nonuniformity of electric current running through the surface of the positive electrode can be restrained and electric current of excellent uniformity can run through the surface. Accordingly, galvanization membrane produced by the system has excellent uniformity. Therefore, corrosion resistance of the galvanization membrane improves.

Further, in the galvanization system in the embodiment of the present invention, the coating treatment can be conducted by lower voltage than that of conventional coating treatments because the positive electrode is constructed as described above. Accordingly, electric energy can be saved. In particular, with respect to conventional zincate bath galvanizations, the coating treatment is conducted by a voltage of 7 to 8V in a rack galvanizing and by a voltage of 12 to 13V in a rotation galvanizing. On the other hand, with respect to the galvanization system in the embodiment of the present invention, the coating treatment can be conducted by a voltage of less than 5V in a rack galvanizing and by a voltage of less than 8V in a barrel galvanizing, and electric energy can be saved by over about 30%.

If needed, the object is set in the acid bath and neutralized after the coating treatment.

Then, if needed, the object is set in an aftertreatment bath including acid aqueous solution including at least one selected from the group consisting of Cr, Co, Zn, Ni and Ag, and at least one selected from the group consisting of chlorine ion, sulfate ion and nitrate ion, and the aftertreatment is conducted in order to keep the excellent appearance of the produced galvanization membrane. If a concentration of at least one selected from the group consisting of Cr, Co, Zn, Ni and Ag is low, it is difficult to get good results. If the concentration is high, the effect decreases and its cost increases because of excess quantity of the ingredients. Accordingly, it is preferable to set appropriate concentrations. For example, the concentration of Cr is preferably about 0.1 to about 30 g/l, more preferably about 0.2 to about 15 g/l. For more details, it depends on other ingredients. For example, if organic acid is included, the concentration of Cr is preferably about 1 to 10 g/l. If organic acid is not included, the concentration of Cr is preferably about 0.3 to 5 g/l. The concentration of Co is also preferably about 0.1 to about 15 g/l, more preferably about 0.3 to about 10 g/l, further preferably about 0.5 to about 5 g/l. In addition, other types of metal ions, for example, Mg, Ca, Zr, V, Al, Fe and the like can be included. Total concentration of at least one selected from the group consisting of chlorine ion, sulfate ion and nitrate ion is preferably about 1 to about 300 g/l, more preferably about 3 to about 100 g/l. These ions can be provided by acid such as sulfuric acid and nitric acid, and by compounds such as chromium sulfate and chromium nitrate. Carboxylic acid and the like can be used as the organic acid, and the total concentration is about 1 to about 80 g/l, preferably about 3 to about 50 g/l. Mole ratio of organic acid and Cr (Organic acid/Cr) is about 0.1 to 6, preferably about 0.4 to 2.5. If a volume of the organic acid is little, the solution becomes unstable, and precipitation is produced or corrosion resistance deteriorates. If a volume of the organic acid is excess, its cost and COD in waste effluent increase and strain on environment increases.

The aftertreatment is conducted to set the object in the aftertreatment bath of pH about 1 to about 6.5 at about 10 to about 60° C., preferably about 15 to about 45° C., for about 1 to about 80 seconds, preferably about 5 to about 60 seconds. If the object is set in the aftertreatment bath once, pH is preferably about 1 to about 4.5, more preferably about 1.5 to about 4. If the object is set more than once, the first setting is as described above, and the settings after the first are conducted preferably at pH about 3.5 to about 6.5, more preferably at pH about 4.0 to about 5.5.

If it is practically necessary to control friction coefficient and the like and to improve corrosion resistance further, the object is treated with alkaline aqueous solution including at least one selected from the group consisting of silica, acrylate resin, wax and silica resin. The concentration thereof is about 1 to about 500 g/l, and it is determined according to required friction coefficient, corrosion resistance and the like. Examples of usable silica may include normal silica and colloidal silica, and various types of silica product produced by Fuso Chemical, Nissan Chemical and the like can be used. The concentration of silica is about 3 to about 50 g/l, preferably about 5 to about 20 g/l. If a volume of silica is little, the effect can be hardly provided. If the volume is much, its cost increases and the appearance of the produced galvanization membrane deteriorates. Examples of the acrylate resin may include “ALMATEX” produced by Mitsui Chemical and “ACRYSET” produced by Nippon Shokubai. Examples of the silica resin and wax may also include commercially available products, for example, “SS-N series” produced by Exousia and polyethylene wax.

### EXAMPLES

Examples of the present invention are described below. However, they are provided for a better understanding of the present invention, and do not intend to limitations of the present invention.

### Example 1

As a pretreatment, a bolt was set in a solution including 10 g/l of UPON LS-250, 5 g/l of sodium phosphate, 30 g/l of potassium hydrate, 5 g/l of EDTA 4 Na and 1 g/l of sodium tartrate at 60° C. for 20 minutes. Then the bolt was electrolyzed at 0.7 A/dm² of current density of the negative electrode for 5 minutes in a solution including 5 g/l of diethanolamine. Then the bolt was set in a solution including 150 g/l of hydrochloric acid at 25° C. for 10 minutes, and electrolyzed at 1.5 A/dm² of current density of the negative electrode in a solution including 5 g/l of triethanolamine at 50° C. Washing before galvanizing was completed by the above treatments.

After the washing, a rotation galvanizing was conducted to the bolt with a positive electrode as described in FIG. 1. One side (L) of the positive electrode opposing to a barrel was 4 mm. Plural positive electrodes were used, their installation intervals were 15 mm, and the average current density at a surface of the positive electrode opposing to the object was 10 A/dm².

A zincate bath including 11 g/l of Zn, 110 g/l of sodium hydrate, 2 g/l of the polymer of the above formula (I) and 0.4 g/l of vanillin was used as the galvanizing solution, a galvanizing was conducted in the galvanizing solution at 45° C. at 13V for 15 minutes, then metallized membrane of about 7 μm thick was produced. After the galvanizing, a dehydrogenation treatment was conducted to the bolt at 200° C. for 4 hours. Then the bolt was set in a solution at pH 2.0 including 1 g/l of trivalent chrome, 20 g/l of colloidal silica, 4 g/l of sulfate ion, 10 g/l of nitrate ion and 0.8 g/l of Co at 25° C. for 45 seconds with stirring and was dried, then Example 1 was produced.

In the polymer of the formula (I) in this example, R1, R2 and R3 indicate CH₃, and n indicates 10.

### Example 2

As a pretreatment, a bolt was set in a solution including 8 g/l of LEOX CC-90, 7 g/l of UPON LS-200, 5 g/l of sodium pyrophosphate, 40 g/l of sodium hydrate, 3 g/l of EDTA 4 Na, 1 g/l of monoethanolamine and 21 g/l of sodium gluconate at 60° C. for 20 minutes. Then the bolt was electrolyzed at 1 A/dm² of current density of the negative electrode for 5 minutes in a solution including 7 g/l of diethanolamine. Then the bolt was set in a solution including 180 g/l of hydrochloric acid at 25° C. for 7 minutes, and electrolyzed at 1 A/dm² of current density of the negative electrode in a solution including 8 g/l of triethanolamine at 50° C. Washing before galvanizing was completed by the above treatments.

After the washing, a rotation galvanizing was conducted to the bolt with a rod-like iron positive electrode bending at lower ¼ thereof along the barrel as described in FIG. 1. One side (L) of the positive electrode opposing to a barrel was 8 mm. Plural positive electrodes were used, their installation intervals were 25 mm, and the average current density at a surface of the positive electrode opposing to the object was 8 A/dm².

A zincate bath including 35 g/l of Zn, 160 g/l of sodium hydrate, 1.5 g/l of the polymer of the above formula (I) as described in Example 1, 0.3 g/l of a polymer of the formula (II), 0.3 g/l of benzylpyridiniumcarboxylate and 0.5 g/l of ethylvanillin was used as the galvanizing solution, and a galvanizing was conducted in the galvanizing solution at 35° C. at 7V for 20 minutes. After the galvanizing, a dehydrogenation treatment was conducted to the bolt at 200° C. for 4 hours. Then the bolt was set in a solution at pH 1.8 including 6 g/l of trivalent chrome, 10 g/l of malonic acid, 20 g/l of colloidal silica, 4 g/l of sulfate ion, 10 g/l of nitrate ion and 0.8 g/l of Co at 50° C. for 50 seconds with stirring and was dried, then Example 2 was produced.

In the polymer of the formula (II) in this example, R1, R2, R3 and R4 indicate CH₃, R5 indicates —CH₂—CH₂—O—CH₂—CH₂, n indicates 6, a indicates 3, b indicates 3 and Y indicates O.

### Example 3

After washing as described in Example 2, a galvanizing was conducted to the bolt in a zincate bath having galvanizing solution including 20 g/l of Zn, 130 g/l of sodium hydrate, 0.5 g/l of the polymer of the above formula (I) as described in Example 1, 0.7 g/l of a reaction product of dimethylaminoethyl amine and dichloroethylether at a rate of about 1.5 to about 1, 0.2 g/l of benzylpyridiniumcarboxylate and 0.3 g/l of ethylvanillin. Plural rod-like iron positive electrodes were used (their installation intervals were 20 mm) and one side (L) of the positive electrode opposing to a barrel was 5 mm. The average current density at a surface of the positive electrode opposing to the object was 5 A/dm². The galvanizing was conducted in the galvanizing solution at 35° C. at 8V for 15 minutes. After the galvanizing, a dehydrogenation treatment was conducted to the bolt at 200° C. for 4 hours. Then the bolt was set in a solution at pH 2.4 including 1.8 g/l of trivalent chrome, 0.2 g/l of sulfuric acid, 1.5 g/l of phosphoric acid, 4 g/l of sodium hyposulfite, 6.5 g/l of sodium nitrate and 1.2 g/l of Co at 35° C. for 40 seconds with stirring. Then the bolt was set in a solution at pH 5.0 including 5 g/l of trivalent chrome, 4 g/l of Zn, 1.5 g/l of Co, 5 g/l of sodium phosphate and 2 g/l of oxalic acid at 40° C. for 10 seconds, and was dried, then Example 3 was produced.

### Example 4

After washing as described in Example 2, a galvanizing was conducted to the bolt in a zincate bath having galvanizing solution including 20 g/l of Zn, 130 g/l of sodium hydrate, 1.0 g/l of the polymer of the above formula (I) as described in Example 1, 0.2 g/l of the polymer of the above formula (II) as described in Example 2, 0.3 g/l of a reaction product of dimethylaminoethyl amine and dichloroethylether at a rate of about 1.4 to about 1, 0.2 g/l of benzylpyridiniumcarboxylate and 0.3 g/l of vanillin. Plural rod-like iron positive electrodes were used (their installation intervals were 10 mm) and one side (L) of the positive electrode opposing to a barrel was 4 mm. The average current density at a surface of the positive electrode opposing to the object was 6.0 A/dm². The galvanizing was conducted in the galvanizing solution at 35° C. at 2.0 A/dm² of the average current density at a surface of the negative electrode for 15 minutes. After the galvanizing, a dehydrogenation treatment was conducted to the bolt at 200° C. for 4 hours. Then the bolt was set in a solution at pH 2.0 including 6 g/l of trivalent chrome, 10 g/l of malonic acid, 20 g/l of colloidal silica, 4 g/l of sulfate ion, 10 g/l of nitrate ion and 0.8 g/l of Co at 25° C. for 45 seconds with stirring and was dried. Then the bolt was set in alkaline solution including 5 g/l of acrylate resin, 2 g/l of colloidal silica and 0.3 g/l of polyethylene wax at 25° C. for 8 seconds, and was dried, then Example 4 was produced.

### Example 5

After washing as described in Example 1, a galvanizing was conducted to the bolt in a zincate bath having galvanizing solution including 11 g/l of Zn, 110 g/l of sodium hydrate, 2 g/l of the polymer of the above formula (I) as described in Example 1 and 0.4 g/l of vanillin. Plural rod-like iron positive electrodes were used, their installation intervals were 30 mm, and one side (L) of the positive electrode opposing to a barrel was 4 mm. Plural positive electrodes were used and the average current density at a surface of the positive electrode opposing to the object was 10 A/dm². The galvanizing was conducted in the galvanizing solution at 45° C. at 13V for 15 minutes. By the above treatment, metallized membrane of about 7 μm thick was produced. After the galvanizing, a dehydrogenation treatment was conducted to the bolt at 200° C. for 4 hours. Then the bolt was set in a solution at pH 2.0 including 1 g/l of trivalent chrome, 20 g/l of colloidal silica, 4 g/l of sulfate ion, 10 g/l of nitrate ion and 0.8 g/l of Co at 25° C. for 45 seconds with stirring, and was dried, then Example 5 was produced.

### Example 6

After washing as described in Example 1, a galvanizing was conducted to the bolt in a zincate bath having galvanizing solution including 40 g/l of Zn, 160 g/l of sodium hydrate, 2.5 g/l of the polymer of the above formula (I) as described in Example 1, 0.3 g/l of the polymer of the above formula (II) as described in Example 2, 0.3 g/l of benzylpyridiniumcarboxylate and 0.5 g/l of ethylvanillin. As the galvanizing, a rotation galvanizing was conducted to the bolt with a rod-like iron positive electrode bending at lower ¼ thereof along the barrel as described in FIG. 1. One side (L) of the positive electrode opposing to a barrel was 25 mm. Plural positive electrodes were used, their installation intervals were 15 mm, and the average current density at a surface of the positive electrode opposing to the object was 12 A/dm². The galvanizing was conducted in the galvanizing solution at 40° C. at 7V for 20 minutes. After the galvanizing, a dehydrogenation treatment was conducted to the bolt at 200° C. for 4 hours. Then the bolt was set in a solution at pH 1.8 including 6 g/l of trivalent chrome, 10 g/l of malonic acid, 20 g/l of colloidal silica, 4 g/l of sulfate ion, 10 g/l of nitrate ion and 0.8 g/l of Co at 50° C. for 50 seconds with stirring, and was dried, then Example 6 was produced.

### Example 7

After washing as described in Example 2, a galvanizing was conducted to the bolt in a zincate bath having galvanizing solution including 20 g/l of Zn, 145 g/l of sodium hydrate, 2 g/l of the polymer of the above formula (I) as described in Example 1 and 0.4 g/l of vanillin. Plural Rod-like iron positive electrodes were used, their installation intervals were 20 mm, and one side (L) of the positive electrode opposing to a barrel was 20 mm. The average current density at a surface of the positive electrode opposing to the object was 10 A/dm². The galvanizing was conducted in the galvanizing solution at 45° C. at 13V for 15 minutes. By the above treatment, metallized membrane of about 7 μm thick was produced. After the galvanizing, a dehydrogenation treatment was conducted to the bolt at 200° C. for 4 hours. Then the bolt was set in a solution at pH 2.0 including 1 g/l of trivalent chrome, 20 g/l of colloidal silica, 4 g/l of sulfate ion, 10 g/l of nitrate ion and 0.8 g/l of Co at 25° C. for 45 seconds with stirring, and was dried, then Example 7 was produced.

### Example 8

After washing as described in Example 2, a galvanizing was conducted to the bolt in a zincate bath having galvanizing solution including 25 g/l of Zn, 135 g/l of sodium hydrate, 1.0 g/l of the polymer of the above formula (I) as described in Example 1, 0.2 g/l of the polymer of the above formula (II) as described in Example 2, 0.3 g/l of a reaction product of dimethylaminoethyl amine and dichloroethylether at a rate of about 1.4 to about 1, 0.2 g/l of benzylpyridiniumcarboxylate and 0.3 g/l of vanillin. Plural rod-like iron positive electrodes were used (their installation intervals were 30 mm) and one side (L) of the positive electrode opposing to a barrel was 22 mm. The average current density at a surface of the positive electrode opposing to the object was 10 A/dm².

The galvanizing was conducted in the galvanizing solution at 30° C. at 2.0 A/dm² of the average current density at a surface of the negative electrode for 15 minutes. After the galvanizing, a dehydrogenation treatment was conducted to the bolt at 200° C. for 4 hours. Then the bolt was set in a solution at pH 2.0 including 6 g/l of trivalent chrome, 10 g/l of malonic acid, 20 g/l of colloidal silica, 4 g/l of sulfate ion, 10 g/l of nitrate ion and 0.8 g/l of Co at 25° C. for 45 seconds with stirring and was dried. Then the bolt was set in alkaline solution including 5 g/l of acrylate resin, 2 g/l of colloidal silica and 0.3 g/l of polyethylene wax at 25° C. for 8 seconds, and was dried, then Example 8 was produced.

### Example 9

The same treatments as Example 1 were conducted with the exception that the one side (L) of the positive electrodes was 15 mm.

### Example 10

The same treatments as Example 2 were conducted with the exception that the one side (L) of the positive electrodes was 12 mm and their installation intervals were 20 mm.

### Example 11

The same treatments as Example 2 were conducted with the exception that the one side (L) of the positive electrodes was 18 mm and their installation intervals were 10 mm.

### Example 12

The same treatments as Example 1 were conducted with the exception that the one side (L) of the positive electrodes was 10 mm and their installation intervals were 15 mm.

### Comparative example 1

As a positive electrode, zinc plates (width: about 200 mm-length: about 1000 mm-thickness: about 35 mm, length of the shortest side in a surface of the positive electrode opposing to the object: about 200 mm) that used in common galvanizing treatment were used. As for the rest, same treatments as described in Example 3 were conducted.

### Comparative example 2

As a positive electrode, iron plates having a size being the same as that of the zinc plates of Comparative example 1 were used. As for the rest, same treatments as described in Example 3 were conducted.

### Comparative example 3

As a positive electrode, a zinc ball (diameter: about 50 mm) set in an iron case (width: about 200 mm-length: about 1000 mm-thickness: about 75 mm) was used. As for the rest, same treatments as described in Example 2 were conducted.

Appearance evaluation tests and corrosion resistance evaluation tests with salt spray according to JIS Z2371 were conducted to Examples and Comparative examples. Results are shown in Table 1.

TABLE 1

| | Appearance | |
|---|---|---|
| | evaluation | Corrosion resistance evaluation |
| Example 1 | uniform/excellent | white rust was not found for 120 hours. |
| | | red rust was not found for 240 hours. |
| Example 2 | uniform/excellent | white rust was not found for 120 hours. |
| | | red rust was not found for 240 hours. |
| Example 3 | uniform/excellent | white rust was not found for 120 hours. |
| | | red rust was not found for 240 hours. |
| Example 4 | uniform/excellent | white rust was not found for 120 hours. |
| | | red rust was not found for 240 hours. |
| Example 5 | uniform/excellent | white rust was not found for 120 hours. |
| | | red rust was not found for 240 hours. |
| Example 6 | uniform/excellent | white rust was not found for 120 hours. |
| | | red rust was not found for 240 hours. |
| Example 7 | uniform/excellent | white rust was not found for 120 hours. |
| | | red rust was not found for 240 hours. |
| Example 8 | uniform/excellent | white rust was not found for 120 hours. |
| | | red rust was not found for 240 hours. |
| Example 9 | uniform/excellent | white rust was not found for 120 hours. |
| | | red rust was not found for 240 hours. |
| Example 10 | uniform/excellent | white rust was not found for 120 hours. |
| | | red rust was not found for 240 hours. |
| Example 11 | uniform/excellent | white rust was not found for 120 hours. |
| | | red rust was not found for 240 hours. |
| Example 12 | uniform/excellent | white rust was not found for 120 hours. |
| | | red rust was not found for 240 hours. |
| Comparative | ununiform | white rust was found in 48 hours. |
| example 1 | | red rust was found in 144 hours. |
| Comparative | ununiform | white rust was found in 48 hours. |
| example 2 | | red rust was found in 144 hours. |
| Comparative | ununiform | white rust was found in 48 hours. |
| example 3 | | red rust was found in 144 hours. |

What is claimed is:

1. A galvanization system comprising:
an alkaline galvanization bath comprising galvanizing solution including about 7 to about 60 g/l of Zn, about 70 to about 200 g/l of alkali hydroxide and about 0.01 to about 5 g/l of additives;
a positive electrode which is insoluble in the galvanizing solution, having an opposed surface to an object which is supposed to be set in the alkaline galvanization bath and galvanized; and
a negative electrode,
wherein the opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm.

2. The galvanization system according to claim 1, further comprising a washing bath that the object is supposed to be set in before the coating treatment, including about 5 to about 100 g/l of alkali hydroxide and at least one selected from the group consisting of (a) about 1 to about 100 g/l of a surface acting agent, (b) organic acid or salt thereof, (c) phosphorus oxygen acid and (d) an aliphatic amine compound.

3. The galvanization system according to claim 2, further comprising an acid bath that the object is supposed to be set in after the washing treatment in the washing bath and before the coating treatment, or set in during multiple times of the washing treatment and before the coating treatment.

4. The galvanization system according to claim 1, further comprising an acid bath that the object is supposed to be set in after the coating treatment.

5. The galvanization system according to claim 1, further comprising an aftertreatment bath that the object is supposed to be set in after the coating treatment and treated, wherein the aftertreatment bath includes acid aqueous solution including at least one selected from the group consisting of Cr, Co, Zn, Ni and Ag, and at least one selected from the group consisting of chlorine ion, sulfate ion and nitrate ion.

6. The galvanization system according to claim 4, wherein the acid aqueous solution further comprises at least one selected from the group consisting of silica, organic acid, phosphorus oxygen acid and fluorine compound.

7. The galvanization system according to claim 4, further comprising an alkaline treatment part that treats the object with alkaline aqueous solution including at least one selected from the group consisting of silica, acrylate resin, wax and silica resin after the aftertreatment.

8. The galvanization system according to claim 1, wherein the opposed surface of the positive electrode is formed in a rectangular pattern having a side over 3 mm and equal to or less than 25 mm, which connects arbitrary two apexes of the pattern, in a polygonal pattern having a vertical line over 3 mm and equal to or less than 25 mm, drawn between an arbitrary apex and an arbitrary side of the pattern, or in a circular pattern having a diameter over 3 mm and equal to or less than 25 mm.

9. The galvanization system according to claim 1, wherein the positive electrode is made of Fe, carbon, Ni, Co, stainless steel, Ti or alloyed metal including at least one selected from the group consisting thereof.

10. The galvanization system according to claim 1, wherein the plural positive electrodes are set in parallel.

11. The galvanization system according to claim 1, wherein the additives comprises:
a polymer having a structure of the formula (I); and 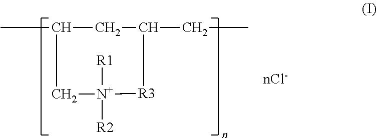
(In the formula (I), R1 and R2 indicate H, CH₃, C₂H₅, C₃H₇ or C₄H₉, R3 indicates CH₂, C₂H₄ or C₃H₆, n indicates an integral number equal to or more than 1.)
a polymer having a structure of the formula (II); 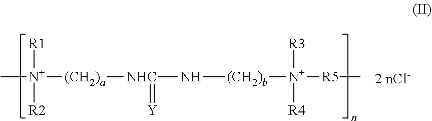
(In the formula (II), R1, R2, R3 and R4 indicate H, CH₃, C₂H₅, C₃H₇ or C₄H₉—CH₂—CH(OH)—CH₂CH₂(OCCH₂CH₂)XOH (X=0 to 6), R5 indicates —CH₂—CH₂—O—CH₂—CH₂—, —(CF₁₂—CH₂—O)₂—CH₂—CH₂— or —CH₂—CH(OH)—CH₂—O—CH₂—CH(OH)—CH₂—, a and b indicate 2 to 4, n indicates an integral number equal to or more than 1, Y indicates S or O.)
and further comprises at least one selected from the group consisting of:
a reaction product of aliphatic amine and epihalohydrin;
a reaction product of (a) urea or thiourea, (b) dialkylaminoethylamine and/or dialkylaminopropylamine and (c) dichloroalkylether; and
polyethyleneimine compound.

12. The galvanization system according to claim 1, wherein the additives comprises at least one selected from the group consisting of:
aromatic aldehyde and derivatives thereof;
benzylpyridiniumcarboxylate;
surface acting agent;
(a) nicotine acid and (b) halogenated hydrocarbon; and
a reaction product of alkylene oxide, halogen ether and epihalohydrin.

13. A method for galvanizing a surface of an object, using a galvanization system comprising:
an alkaline galvanization bath comprising galvanizing solution including about 7 to about 60 g/l of Zn, about 70 to about 200 g/l of alkali hydroxide and about 0.01 to about 5 g/l of additives;
a positive electrode which is insoluble in the galvanizing solution, having an opposed surface to an object which is supposed to be set in the alkaline galvanization bath and galvanized; and
a negative electrode,
wherein the opposed surface of the positive electrode is formed in a polygonal pattern having a side equal to or less than 30 mm, which connects arbitrary two apexes of the pattern, in a polygonal pattern having a vertical line equal to or less than 30 mm, drawn between an arbitrary apex and an arbitrary side of the pattern, or in a circular pattern having a diameter equal to or less than 30 mm.

14. The method according to claim 12, wherein an average current density of the negative electrode is about 0.4 to about 50 A/dm².

15. The method according to claim 12, wherein an average current density of the opposed surface of the positive electrode is about 0.5 to about 100 A/dm².

16. The method according to claim 12, wherein an average galvanizing rate is equal to or more than about 0.1 μm/min in a barrel galvanizing and equal to or more than about 0.3 μm/min in a rack galvanizing.

17. Additives for the galvanization system according to claim 1 comprising:
a polymer having a structure of the formula (I); and 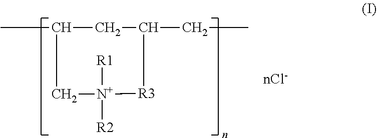
(In the formula (I), R1 and R2 indicate H, CH₃, C₂H₅, C₃H₇ or C₄H₉, R3 indicates CH₂, C₂H₄ or C₃H₆, n indicates an integral number equal to or more than 1.)
a polymer having a structure of the formula (II); 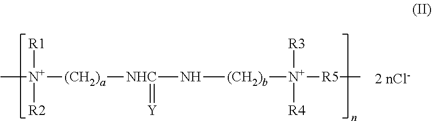
(In the formula (II), R1, R2, R3 and R4 indicate H, CH₃, C₂H₅, C₃H₇ or C₄H₉—CH₂—CH(OH)—CH₂CH₂(OCCH₂CH₂)XOH (X=0 to 6), R5 indicates —CH₂—CH₂—O—CH₂—CH₂—, —(CH₂—CH₂—O)₂—CH₂—CH₂— or —CH₂—CH(OH)—CH₂—O—CH₂—CH(OH)—CH₂—, a and b indicate 2 to 4, n indicates an integral number equal to or more than 1, Y indicates S or O.)
and further comprises at least one selected from the group consisting of:
a reaction product of aliphatic amine and epihalohydrin;
a reaction product of (a) urea or thiourea, (b) dialkylaminoethylamine and/or dialkylaminopropylamine and (c) dichloroalkylether; and
polyethyleneimine compound.

18. A washing agent for the washing bath of the galvanization system according to claim 1 comprising at least one selected from the group consisting of anionic system surface acting agent, nonionic system surface acting agent, organic carboxylic acid or salt thereof, EDTA salt, NTA salt, phosphoric acid, pyrophoric acid, phosphorous acid, hypophosphorous acid or salt thereof, aliphatic amine of carbon number equal to or less than 12 or reaction product of the aliphatic amine and epihalohydrin.

19. An aftertreatment acid aqueous solution for the aftertreatment bath of the galvanization system according to claim 1 comprising at least one selected from the group consisting of Cr, Co, Zn, Ni and Ag, and at least one selected from the group consisting of chlorine ion, sulfate ion and nitrate ion, and optionally at least one selected from the group consisting of silica, organic acid, phosphorus oxygen acid and fluorine compound.

20. An aftertreatment alkaline aqueous solution for the alkaline treatment part of the galvanization system according to claim 1 comprising at least one selected from the group consisting of silica, acrylate resin, wax and silica resin.
